(19) United States
(12) Patent Application Publication
(10) Pub. No.: US 2017/0240368 A1
(43) Pub. Date: Aug. 24, 2017

(54) METHOD FOR WINDING A GLASS RIBBON, APPARATUS THEREFOR, AND THE GLASS ROLL PRODUCED THEREBY

(71) Applicant: SCHOTT AG, Mainz (DE)

(72) Inventors: Thomas Roßmeier, Bodenheim (DE); Matthias Jotz, Alfeld (Leine) (DE); Thomas Wiegel, Alfeld (DE); Clemens Ottermann, Hattersheim (DE); Jürgen Vogt, Oberheimbach (DE)

(73) Assignee: SCHOTT AG, Mainz (DE)

(21) Appl. No.: 15/071,429

(22) Filed: Mar. 16, 2016

(30) Foreign Application Priority Data
Feb. 22, 2016 (DE) 102016202685.2

(51) Int. Cl. B65H 18/08; B65H 18/00; C03C 3/112; C03C 3/118; C03C 3/097; C03C 3/091; C03C 3/093; C03C 3/083; C03C 3/085; C03C 3/095; C03C 4/02; C03C 3/089; C03C 3/087; C03C 3/078; C03B 40/00

(52) U.S. Cl. CPC B65H 18/08; C03B 40/00; B65H 18/00; C03C 3/112; C03C 3/118; C03C 3/097; C03C 3/091; C03C 3/093; C03C 3/083; C03C 3/085; C03C 3/095; C03C 4/02; C03C 3/089; C03C 3/087; C03C 3/078; B65H 2701/1727; B65H 2301/41421; B65H 2701/1716; B65H 2701/1252; C03C 2204/00

(57) ABSTRACT

A method for winding up a glass ribbon is provided, in which, prior to winding up the glass ribbon, the two surfaces of the glass ribbon are each initially treated with a water-containing medium and subsequently dried so as to produce a defined content of water molecules on the two surfaces, by achieving a saturation of the surfaces of the glass ribbon with water, without bringing about an excess of water molecules. A glass roll is produced in which the electrostatic charge of the glass surface is reduced and, as a result, any undesired excess adherence of the glass surface to an interleaf material is prevented and, in this way, glass breakage, in particular during winding up and/or unwinding of the glass roll, can be markedly reduced.

### CROSS REFERENCE TO RELATED APPLICATIONS

This application claims benefit under 35 U.S.C. §119(a) of German Patent Application No. 10 2015 003 334.4 filed Mar. 16, 2015 and German Patent Application No. 10 2016 202 685.2 filed Feb. 22, 2016, the entire contents of both of which are incorporated herein by reference.

### BACKGROUND

1. Field of the Invention

The present invention relates to a method for winding a glass strip or ribbon, an apparatus for carrying out the method, and the glass roll produced thereby.

2. Description of Related Art

The most recent trends show that a glass that is used for electronic applications, in particular, is becoming increasingly thinner. The flexibility of the glass increases with the decreasing thickness thereof. The thinner the glass becomes, the more sensitive it is to breakage. Therefore, handling is markedly more difficult for thin glass and the form in which it is stored and packed is of growing importance for eventual transport. This plays a role particularly for thin glass with a thickness of 300 μm or less.

Therefore, there have already been proposals in the prior art to wind thin glass into a roll so as to simplify the handling thereof. This type of packing or storage exploits the flexibility of the glass and has numerous advantages, such as high savings in terms of space, thereby enabling glass ribbons of even greater than 100 meters in length to be handled now in a simple manner.

A drawback of such types of rolls is that the thin glass is extremely sensitive to defects, in particular surface defects. These defects are, for example, bubbles, inclusions, devitrifications, and microcracks, which can lead to breakage of the glass. The consequences of glass defects and flaws are even more drastic in the wound state, because a glass fracture propagates itself in the wound-up roll and the glass can thereby crack over meters, for example. In order to prevent this, it has been found to be advantageous to prevent any direct contact of the surface of the glass on the roll with itself, so that, typically, an interleaf material is wound together with the glass, so that no direct contact of one part of the glass surface with another part of the glass surface results.

There are numerous proposals from the prior art for creating advantageous conditions during winding of a glass ribbon and in the wound-up roll.

Thus, WO 2013/066672 A1 describes a glass roll as well as a method and an apparatus for the production thereof. Described, in particular, is a glass roll comprising: a glass ribbon and an interleaf material, which are rolled together so as to be disposed in alternating layers, wherein a layer of the interleaf material adheres to an adjacent layer of the glass ribbon by an electrostatic force, said electrostatic force having a value such that the shear force required to cause slip between the interleaf material and the glass ribbon is at least 10 times greater than when they are not electrostatically pinned together. To this end, the glass ribbon and the interleaf are actively charged, with either the glass ribbon being positive and the interleaf being negative, or vice versa, so as to fix the layers precisely on each other. During unwinding, they are again discharged.

Furthermore, U.S. Pat. No. 8,241,751 B₂ discloses a glass roll as well as a method for producing the glass roll, wherein the glass roll is formed by winding a glass film into a roll, with the glass film having a minimum winding radius (R) that satisfies the following relation:

$$R \geq \frac{T}{2} ( \frac{2.3}{σ} E - 1 )$$

where σ represents the flexural strength of the glass film obtained by a three-point bending test, T represents the thickness of the glass film, and E represents Young's modulus of the glass film. A further condition that is described is that the glass roll has to be sufficiently dry, with moisture being strictly excluded. Prior to use or further processing of the glass roll, therefore, free moisture on the surface of the glass has to be completely removed. Therefore, a conditioning or drying of the glass roll prior to further processing is an essential prerequisite.

Furthermore, US 2011/0192878 A1 describes, in particular, in paragraphs [0071] and [0072] as well as in FIGS. 2 and 9, an apparatus in which a glass film is unwound from a glass roll, dipped into a cleaning liquid, such as water, and then dried, the static charge in the glass film is eliminated, and, finally, the glass film is wound up again. A drawback of this apparatus and hence also of the method carried out with it is that the glass film is dipped into the cleaning liquid such as water. Thin glasses and ultrathin glasses exhibit only a relatively low fracture strength, so that a strong type of stress such as dipping into a liquid would be associated with a high risk of breakage and therefore significantly high failure rates for the glasses. In addition, the buoyancy produced by the water would not only increase the risk of breakage, but would also make markedly difficult a constant conveyor-belt conveyance of the glass ribbon through the water.

Finally, WO 2012/176 594 A1 describes a thin-film glass transfer method as well as a device for it. In order to prevent the creation of cracks in a thin glass film, the relative humidity is adjusted to at most 40% in the surroundings of the thin glass film. More preferably, the relative humidity is adjusted to at most 10% and, even more preferably, to at most 1%. This is achieved by an appropriate drying method, for example, exposure to blown-in dry air. This relative humidity of 40% or less is intended to prevent the glass from breaking during winding and unwinding.

However, it has been found that some problems persist during winding and unwinding of a glass ribbon and are not eliminated by the prior art discussed above. Thus, there exists an increased danger of contamination, in particular due to electrostatic charging of the glass surface during transport and also prior to winding up into the glass roll. Furthermore, when the surfaces are brought together with the interleaf material during winding, this often results in the surfaces adhering together too early and too strongly, so that any possibilities for correction no longer exist.

Furthermore, when a glass roll is unwound, too strong an electrostatic adherence of the glass surface to the interleaf material can lead to glass breakage due to strong adhesion of the materials. In addition, it was found that the glass roll exhibits a glass breakage tendency due to the occurrence of stress crack corrosion when the moisture content in the roll is too high. As is known, stress crack corrosion is crack formation in a material under the simultaneous influence of a tensile stress, which also acts in the form of intrinsic stress and in conjunction with a water-containing medium, for example, pure water. The water usually enhances the effect of stress crack corrosion in the glass roll to a special extent.

### SUMMARY

The present invention is therefore based on the object of remedying the problems discussed above and overcoming the drawbacks of the prior art. In particular, a method is to be provided in which a glass roll is produced in which the electrostatic charge of the glass surface is reduced and any undesired excessive adherence of the glass surface to an interleaf material is thereby prevented and, as a result of which, glass breakage, particularly during winding or unwinding of the glass roll can be markedly reduced.

The object presented above is achieved in accordance with the invention by a method for winding up a glass ribbon, in particular a thin glass ribbon, in which, prior to the winding of the glass ribbon, the two surfaces of the glass ribbon are each treated initially with a water-containing medium and subsequently dried so as to produce a defined content of water molecules on the two surfaces by saturating the surfaces of the glass ribbon with water, without obtaining an excess of water molecules.

The subject of the invention is also an apparatus for implementing the method, comprising an apparatus for treating the two glass-ribbon surfaces with a water-containing medium, wherein there is no dipping into the water-containing medium, and preferably a spraying or vaporizing of the surfaces of the glass ribbon with a water-containing medium is carried out, and an apparatus for drying the two surfaces of the glass ribbon with retention of a defined content of water molecules on the two surfaces, in each case, by saturating the surfaces of the glass ribbon with water, without obtaining an excess of water molecules.

It has been found in accordance with the invention that, besides the quality of the glass ribbon, such as, for example, the presence of defects or flaws in the glass, as well as the glass-ribbon conveyor(s) and the geometry of the glass ribbon, also the behavior of the surface of the glass ribbon with respect to the interleaf material has a great influence on the winding-up process and also on the number of fractures on the roll. In accordance with the invention and in total departure from the hitherto known prior art, it was found that the electrostatic charge of the roll and hence the ability to wind and unwind it can be influenced positively when a defined water content is present in the surface of the glass ribbon.

In the method according to the invention, therefore, each surface of the glass ribbon is treated initially with a water-containing medium prior to winding up the thin glass ribbon, with preferably a wetting by spraying or vaporizing being carried out. The treatment of the glass ribbon with a water-containing medium is not particularly limited thereby. Any method known to the person skilled in the art for treating a surface can be employed. However, a direct dipping of the thin glass ribbon into a water-containing medium should not be carried out so as to exclude the resulting high risk of breakage. The water-containing medium can be employed as a liquid or in a gaseous form, for example, as a vapor or an aerosol. Preferably, the surface of the glass ribbon is treated by using water vapor.

According to a preferred embodiment, for example, a glass ribbon with its two glass surfaces, preferably cold glass surfaces, can be placed in an atmosphere that is super-saturated with water vapor.

Subsequent to the treatment with a water-containing medium, the water-containing surfaces of the glass ribbon are dried in order to obtain a water film composed of preferably one layer of water molecules on the glass surface. In accordance with the invention, “water film” is understood to be one layer of water molecules (monolayer of water molecules), which especially leads to the saturation of free binding sites on the glass surface, but does not mean any excess of water molecules.

Achieved in this way is a decrease in the local electrical resistance or an increase in the conductivity value and hence the possibility of depleting charges or compensating for charges on the glass surface. The method according to the invention leads to the formation of preferably only one layer of water molecules on the surface, which, in turn, leads to a depletion and a uniform distribution of electrostatic forces over the surface of the entire glass ribbon as well as of the wound-up glass roll. The reduction in the charge of the surface of the glass ribbon leads to a lesser adherence of the glass surface to the interleaf material, as a result of which minor corrections are possible when the glass ribbon is wound up so as to achieve a precise edge positioning of the glass ribbon, even in connection with the interleaf material. In addition, when the glass roll is unwound, the glass breakage that occurs is markedly reduced, because too strong an adhesion between the glass ribbon and the interleaf material is prevented.

When more than one layer of water molecules is created on the glass surface, that is, when a super-saturation of water molecules exists, the stress crack corrosion rises to an undesired degree; that is, increased glass breakage ensues. When the layer of water molecules is too thin, that is, when no continuous layer of water molecules is created on the glass surface, there ensues too high an electrostatic charge of the glass ribbon, as a result of which the adherence of the glass surface to the interleaf material becomes too strong. This leads, in turn, to increased glass breakage. It has now been found in accordance with the invention that one layer of water molecules is present in the case when the glass surface is just saturated with water. As a result of the treatment with water-containing medium, therefore, water molecules initially undergo inclusion in the glass and, in particular, undergo inclusion in one or even in a plurality of layers or else become attached (adsorbed) to the glass. In order to obtain a defined water content on the glass surface after treatment of the respective surface of the glass ribbon with a water-containing medium, the drying is carried out in such a way that one layer of water molecules is present on the surface. In this way, only the free water is removed from the surface (removal of the free moisture, but not the bound or adsorbed moisture), with only the uppermost adsorbed layer of water molecules remaining behind and hence retained. If it is taken into account that the adsorbed water molecules can be removed only above a temperature of greater than 150° C., it is appropriate to carry out a drying in the temperature range x (100° C.>x>150° C.) in order to retain this adsorbed layer of water molecules on the surface. The drying step is to be appropriately fine-tuned and adjusted depending on the chosen glass composition, the glass thickness, the size of the glass surface, and the ambient temperature, in order to obtain the defined water content on the glass surface.

In accordance with the invention, the drying step subsequent to the treatment with water-containing medium is therefore not particularly limited, provided that the defined water content is observed. Any drying method that is known to the person skilled in the art and does not remove the adsorbed water film can be employed. For example, the drying can be carried out by delivering dried air. Another possibility consists in heating the glass ribbon, whereby preferably, a temperature of less than 150° C. is employed in order to be able to better check and control the vaporization. As a result of the heating of the glass ribbon to a temperature x in the above temperature range, preferably of less than 150° C., the water content can be adjusted in the defined range in a straightforward manner. Thus, in accordance with the invention, drying methods that enable a precise control or checking of the rate of vaporization of the water are especially preferred.

The person skilled in the art can determine from the prior art by way of a few orienting tests whether one layer of water molecules has been obtained using the method. In order to demonstrate that a water film in the form of a continuous layer of water molecules is indeed present on the respective surface of the glass ribbon, there exists, for example, the possibility of measuring the surface conductivity of the freshly processed glass ribbon.

The treatment with water-containing medium and the drying of the surface of the glass ribbon should be carried out both on the top side of the glass ribbon (top surface) and also the bottom side of the glass ribbon (bottom surface). Because, when the glass is wound up, there are always two boundaries, namely, top side and bottom side, it is routinely appropriate to treat the two surfaces identically. The top side of the glass film is, for example, that side of the glass ribbon on which the interlayer material is later placed. It is especially appropriate to treat the two surfaces of the glass ribbon by the method according to the invention, because, in this way, the achieved effects, such as a reduction in the electrostatic charge, a reduction in the adherence to other materials, and a lowering of the stress crack corrosion, even in combination with interlayer material, is manifested especially well.

The method according to the invention can be a continuous method, which, for example, is carried out directly after or during the glass production and forming. However, it can also be employed for a single glass ribbon independently of the glass production.

In accordance with the invention, the electrostatic charging is markedly lowered after the method according to the invention has been carried out. In accordance with the invention, the electrostatic charge can be measured in a simple way on the basis of the excess of positive or negative free ions present on a surface, by means of an electric field meter.

The electrostatic charge of the surface of the glass ribbon before the method according to the invention has been carried out lies in a range of about 5 to about 25 kV. After the method according to the invention has been carried out, it lies in a range of about 0 to about 1 kV.

It has further been found that the climatic conditions, such as temperature and humidity, in the surroundings during the creation of the glass roll can have an influence on the behavior of the thin glass. Thus, the climatic conditions act, for example, on the adhesive behavior of thin glass to machine parts and equipment parts, in particular conveyors. The lower the humidity is, the greater is the adhesive behavior. Therefore, it is especially advantageous to adjust a relative air humidity of greater than 50% at 20° C. Advantageously, the humidity can be up to 100%, but ranges of between 50 and 80% at 20° C. are sufficient. According to a preferred embodiment of the present invention, therefore, the humidity during winding is adjusted in the range between 50% and 80% at 20° C. This acts advantageously on the surface of the glass ribbon and on the subsequent winding process as well as on the glass roll itself. When winding is conducted at a relative humidity of between 50% and 80%, it is possible to achieve a marked reduction in glass breakage if a defined water film preferably composed of a continuous layer of water molecules has been created simultaneously on the surface of the glass ribbon.

The given moisture is retained advantageously both during winding up and also during keeping or storage in the form of glass roll. In order that the moisture due to the water film on the surface of the glass ribbon and the elevated air humidity does not become too high in the packing, for example, because this leads to an undesired increase in the stress crack corrosion, it can be advantageous to pack a desiccant together with the glass roll.

According to another preferred embodiment of the present invention, an additional discharge of the surface of the glass ribbon may be advantageous directly prior to winding. This can be achieved, for example, by using carbon brushes, graphite film, passive or active deionizing rods, or the like.

According to an advantageous enhancement of the present invention, preferably a deionization of the air is carried out during winding. Also, a deionization of the glass ribbon and of the interleaf material may be advantageous in order to prevent any non-uniform behavior of the material during winding. The deionization can be achieved by way of one or a plurality of suitable apparatuses, which are known from the prior art to the person skilled in the art.

In accordance with the invention, thin or ultrathin glasses are employed, which are not particularly limited. Accordingly, the glass ribbon is a thin glass ribbon or an extremely thin glass ribbon or ultrathin glass ribbon. In accordance with the invention, thin glasses or ultrathin glasses are understood to be those that have a thickness in the range of ≦300 μm, in particular ≦200 μm, still more preferably ≦100 μm, most preferably ≦50 μm. Particularly preferred are lithium aluminum silicate glasses, soda-lime silicate glasses, borosilicate glasses, aluminosilicate glasses, and glass ceramics.

Lithium aluminum silicate glasses that have the following glass composition or are composed thereof (in wt %) are preferred:

| | |
|---|---|
| Si₂ | 55-69, |
| Al₂O₃ | 19-25, |
| Li₂O | 3-5, |
| Total Na₂O + K₂O | 0-30, |
| Total MgO + CaO + | 0-5, |
| SrO + BaO | |
| ZnO | 0-4, |
| Ti₂ | 0-5, |
| Zr₂ | 0-3, |
| Total Ti₂ + Zr₂ + | 2-6, |
| Sn₂ | |
| P₂O₅ | 0-8, |
| F | 0-1, and |
| B₂O₃ | 0-2, as well as, if need be, additives of |
| | coloring oxides, such as, for example, Nd₂O₃, |
| | Fe₂O₃, CoO, NiO, V₂O₅, Mn₂, CuO, Ce₂, Cr₂O₃, |
| | rare earth oxides in contents of 0-1 wt %, as |
| | well as refining agents, such as As₂O₃, SB₂O₃, |
| | Sn₂, SO₃, Cl, F, Ce₂, in contents of 0-2 wt %. |

Further, soda-lime silicate glasses that have the following glass composition or are composed thereof (in wt %) are preferred:

| | |
|---|---|
| Si₂ | 40-80, |
| Al₂O₃ | 0-6, |
| B₂O₃ | 0-5, |
| Total Li₂O + Na₂O + | 5-30, |
| K₂O | |
| Total MgO + CaO + | 5-30, |
| SrO + BaO + ZnO | |
| Total Ti₂ + Zr₂ | 0-7, and |
| P₂O₅ | 0-2, as well as, if need be, additives of |
| | coloring oxides, such as, for example, Nd₂O₃, |
| | Fe₂O₃, CoO, NiO, V₂O₅, Mn₂, CuO, Ce₂, |
| | Cr₂O₃, rare earth oxides in contents of 0-5 wt % |
| | or, for “black glass,” of 0-15 wt %, as well |
| | as refining agents, such as As₂O₃, SB₂O₃, Sn₂, |
| | SO₃, Cl, F, Ce₂, in contents of 0-2 wt %. |

Further preferably used are borosilicate glasses that have the following glass composition or are composed thereof (in wt %):

| | |
|---|---|
| Si₂ | 60-85, |
| Al₂O₃ | 1-10, |
| B₂O₃ | 5-20, |
| Total Li₂O + Na₂O + | 2-16, |
| K₂O | |
| Total MgO + CaO + | 0-15, |
| SrO + BaO + ZnO | |
| Total Ti₂ + Zr₂ | 0-5, and |
| P₂O₅ | 0-2, as well as, if need be, additives of |
| | coloring oxides, such as, for example, Nd₂O₃, |
| | Fe₂O₃, CoO, NiO, V₂O₅, Mn₂, CuO, Ce₂, |
| | Cr₂O₃, rare earth oxides in contents of 0-5 wt % |
| | or, for “black glass,” of 0-15 wt %, as well |
| | as refining agents, such as As₂O₃, SB₂O₃, Sn₂, |
| | SO₃, Cl, F, Ce₂, in contents of 0-2 wt %. |

Further, alkali aluminosilicate glasses that have the following glass composition or are composed thereof (in wt %) are preferred:

| | |
|---|---|
| Si₂ | 40-75, |
| Al₂O₃ | 10-30, |
| B₂O₃ | 0-20, |
| Total Li₂O + Na₂O + | 4-30, |
| K₂O | |
| Total MgO + CaO + | 0-15, |
| SrO + BaO + ZnO | |
| Total Ti₂ + Zr₂ | 0-15, and |
| P₂O₅ | 0-10, as well as, if need be, additives of |
| | coloring oxides, such as, for example, Nd₂O₃, |
| | Fe₂O₃, CoO, NiO, V₂O₅, Mn₂, CuO, Ce₂, |
| | Cr₂O₃, rare earth oxides in contents of 0-5 wt % |
| | or, for “black glass,” of 0-15 wt %, as well |
| | as refining agents, such as As₂O₃, SB₂O₃, Sn₂, |
| | SO₃, Cl, F, Ce₂, in contents of 0-2 wt %. |

Further, alkali-free aluminosilicate glasses that have the following glass composition or are composed thereof (in wt %) are also preferred:

| | |
|---|---|
| Si₂ | 50-75, |
| Al₂O₃ | 7-25, |
| B₂O₃ | 0-20, |
| Total Li₂O + Na₂O + | 0-0.1, |
| K₂O | |
| Total MgO + CaO + | 5-25, |
| SrO + BaO + ZnO | |
| Total Ti₂ + Zr₂ | 0-10, and |
| P₂O₅ | 0-5, as well as, if need be, additives of |
| | coloring oxides, such as, for example, Nd₂O₃, |
| | Fe₂O₃, CoO, NiO, V₂O₅, Mn₂, CuO, Ce₂, |
| | Cr₂O₃, rare earth oxides in contents of 0-5 wt % |
| | or, for “black glass,” of 0-15 wt %, as well |
| | as refining agents, such as As₂O₃, SB₂O₃, Sn₂, |
| | SO₃, Cl, F, Ce₂, in contents of 0-2 wt %. |

Further, low-alkali aluminosilicate glasses that have the following glass composition or are composed thereof (in wt %) are also preferred:

| | |
|---|---|
| Si₂ | 50-75, |
| Al₂O₃ | 7-25, |
| B₂O₃ | 0-20, |
| Total Li₂O + Na₂O + | 0-4, |
| K₂O | |
| Total MgO + CaO + | 5-25, |
| SrO + BaO + ZnO | |
| Total Ti₂ + Zr₂ | 0-10, and |
| P₂O₅ | 0-5, as well as, if need be, additives of |
| | coloring oxides, such as, for example, Nd₂O₃, |
| | Fe₂O₃, CoO, NiO, V₂O₅, Mn₂, CuO, Ce₂, |
| | Cr₂O₃, rare earth oxides in contentsof 0-5 wt % |
| | or, for “black glass,” of 0-15 wt %, as well |
| | as refining agents, such as As₂O₃, SB₂O₃, Sn₂, |
| | SO₃, Cl, F, Ce₂, in contents of 0-2 wt %. |

The production of the thin glass, before it is wound up on rolls, can obviously be conducted completely at will. Any method known to the person skilled in the art for the production of thin glass can be used; to be mentioned by way of example are downdraw, slot-draw, fusion-draw, updraw, overflow-fusion, float, or redrawing methods.

It is also possible to carry out a surface conditioning of the glass surface for better ability to laminate or to release, for example, an adhesive film. Treatments of this kind are known to the person skilled in the art.

The interleaf material that is employed in accordance with the invention is likewise not further limited. It functions as a protective layer or protective film and preferably has a thickness in the range of 10 μm to 2000 μm. Preferably chosen is a material that exhibits no changes even at higher temperatures, because, in one embodiment, the glass ribbon is heated directly prior to winding to temperatures of <150° C. Therefore, a material that has a softening point above about 150° C., preferably above about 200° C., is preferred. Preferred materials for the interleaf material are polymeric materials. These are chosen most preferably from ionomers, polyethylene, polypropylene, polyvinyl chloride, polyvinylidene chloride, polyvinyl alcohol, polypropylene, polyester, polyamide, such as nylon, polycarbonate, polystyrene, polyacrylonitrile, ethylene vinyl acetate copolymer, ethylene vinyl alcohol copolymer, ethylene methacrylate copolymer, polyimide, cellophane, or other resin materials, paper, or nonwovens. Particularly preferred is a polyethylene or polyvinyl material, paper, corrugated paper, or cardboard, most preferably a polyethylene or polyvinyl foam material.

It may be preferred to wind the interleaf material already one or more times on the roll before beginning to wind the glass ribbon on the roll. This has the advantage of compensating for any unevenness of the reel core as well as of preventing any contact of the somewhat thicker border region with the reel core.

It may also be preferred to wind the interleaf material one or more times on the roll at the end of the winding operation. This has the advantage of effecting a certain protection of the roll against unintentional contact or minor impacts.

As for the winding radius, it is generally to be noted that this radius can markedly differ from radii during storage. It can be larger or smaller. Smaller winding radii create higher tensile stress.

The advantages of the present invention are extraordinarily multifaceted.

Thus, it is possible by means of the method of the present invention to handle thin glass more reliably, in particular, to keep it, to store it, and to pack it. The glass breakage during the winding of thin glass and the storage or transport thereof as well as during unwinding of the glass roll is markedly reduced. This is achieved, on the one hand, by reducing the adherence between the surface of the glass ribbon and the interleaf material, as a result of which it is simpler to position precisely the interleaf material on the surface of the glass ribbon and to protect the glass appropriately. During unwinding, moreover, it is easier to remove the interleaf material from the surface of the glass ribbon once again.

In a surprising way, the glass breakage is markedly diminished by the method according to the invention. In contrast to the prior art, the moisture during winding of the glass ribbon is not lowered or even totally eliminated during winding, but rather markedly increased. In an unanticipated way, it was even found that the specific use of a water film on the surface of the glass ribbon affords especially advantageous properties during winding and/or unwinding of thin glass and the storage thereof.

Further advantageous conditions that can be adjusted are a relative air humidity that is preferably in the range between 50% and 80% at 20° C. during winding, an additional discharge of the surface of the glass ribbon directly prior to winding, and a deionization of the air and/or of the glass ribbon and/or of the interleaf material during winding. The deionization of the glass ribbon and/or of the interleaf material leads to a uniform behavior of the materials during winding.

The subject of the invention is also a glass ribbon for which the two surfaces of the glass ribbon each have a defined content of water molecules on the surface, wherein a saturation of the surfaces of the glass ribbon with water exists in each case, without an excess of water molecules being present.

The invention also relates to a glass sheet, in particular a thin glass sheet, which can be obtained from the glass ribbon described above by separation into pieces by cutting, for example, and for which the two surfaces each have a defined content of water molecules on the surface, wherein a saturation of the glass surfaces with water exists in each case, without an excess of water molecules being present.

The invention also relates to a glass roll, comprising the glass ribbon presented above, which, together with an interleaf material, which is chosen from a polymeric material, is wound up into a glass roll, with the electrostatic charge of the glass ribbon lying in the range of 0 to 1 kV.

### BRIEF DESCRIPTION OF THE DRAWINGS

The invention will be further illustrated below on the basis of drawings, which are not intended to limit the present invention.

FIG. 1 is a schematic illustration of an exemplary embodiment of an apparatus for implementing the method according to the invention, wherein a thin glass ribbon is treated in accordance with the invention and then wound up together with an interleaf material onto a roll;

FIG. 2 a schematic illustration of an exemplary embodiment of another apparatus for implementing the method according to the invention;

FIG. 3 a perspective view of an exemplary embodiment of the present invention in the form of a glass roll in a wound-up state; and

FIG. 4 a plan view onto the glass roll of FIG. 3.

### DETAILED DESCRIPTION

The various elements illustrated in the drawing are only representative and are not necessarily drawn to scale. Certain portions thereof may be exaggerated, whereas others may be minimized. The drawings are intended to illustrate exemplary embodiments of the disclosure that can be understood and implemented in a suitable manner by the person skilled in the art, without limiting the invention. In the figures, identical components and elements are referenced with identical reference numbers and symbols.

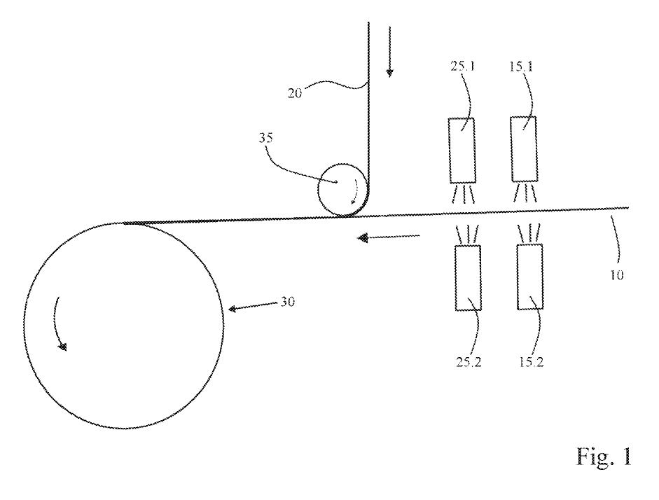

FIG. 1 shows a schematic illustration of an embodiment of an apparatus for implementing the method according to the invention, wherein the glass ribbon 10, made of thin glass, is initially treated in accordance with the method according to the invention and subsequently wound up onto a roll 30 together with an interleaf material 20. First of all, the glass ribbon 10 is prepared. The method according to the invention can directly follow after production of the thin glass, for example, that is, after the forming method. The thin glass can be produced by any method, such as, for example, an overflow, fusion, redraw, or float method.

In the first step of the method according to the invention, after the thin glass has been prepared in the form of a glass ribbon, the two surfaces of the glass ribbon 10 are treated with a water-containing medium. This can be conducted, for example, by means of vaporizers 15.1 and 15.2, which deposit water vapor on the two surfaces of the glass ribbon 10. In the process, one or a plurality of layers of water molecules are formed on the two surfaces of the glass ribbon. In the subsequent drying step, a portion of the water molecules is removed once again by drying. This can be conducted, for example, by means of two drying apparatuses 25.1 and 25₂ A possibility for drying the surfaces of the glass ribbon is, for example, to blow dry air onto the glass surfaces. Another possibility for carrying out the drying is to heat the glass surfaces, albeit preferably below 150° C. so as to carry out a controlled vaporization of the undesired water content. As a result of the treatment with a water-containing medium and the subsequent drying, a continuous water film is obtained on each surface of the glass ribbon 10, so that, preferably, only one layer of water molecules is present on each of the surfaces. Any exceeding or falling short of the defined water content on the surfaces has a detrimental effect on the properties of the glass ribbon, in particular on the electrostatic charge and stress crack corrosion thereof, so that a markedly higher glass breakage is obtained. Only when a defined water content exists on the surface of the glass ribbon 10 can the advantageous properties according to the invention be obtained.

The defined water content can be determined by just a few tests on the surface of the glass ribbon with the chosen glass composition by the person skilled in the art. The water film then lies in the range according to the invention when a saturation of the glass surface just exists and no excess quantities of water are present. In order to demonstrate that a water film is indeed present on the surface of the glass ribbon in the form of a continuous layer of water molecules, the surface conductivity can be measured, for example.

After the method according to the invention has been carried out, the resulting thin glass 10 is wound onto a roll 30. To this end, the interleaf material 20, which is composed of polyethylene foam, for example, is provided. The thickness of the interleaf material 20 generally lies in the range of 10 to 2000 μm. As shown in FIG. 1, the interleaf material 20 can be applied onto the surface of the glass ribbon 10 by means of a roll 35, with the roll 35 rotating in the direction of the arrow. Obviously, other possibilities of feeding the interleaf material 20 and applying it onto the surface of the glass ribbon are known to the person skilled in the art.

Once the interleaf material 20 is situated in the correct position on the surface of the glass ribbon 10, the glass ribbon 10 and the interleaf material 20 are wound up together onto the roll 30, which rotates in the direction of the given arrow. In this way, any direct contact of the glass surfaces with each other is prevented, so that the wound-up thin glass is appropriately protected.

The diameter of the roll 30 increases as more glass ribbon 10 is wound up together with the interleaf material 20.

According to a preferred embodiment of the present invention, the interleaf material 20 can be wound up already one or more times onto the roll 30 (not shown), before the winding up of the glass ribbon 10 onto the roll 30 begins. According to another preferred embodiment, the interleaf material can also be wound up one or more times on the roll at the end of the winding operation in order to protect the roll against any unintentional contact or minor impacts.

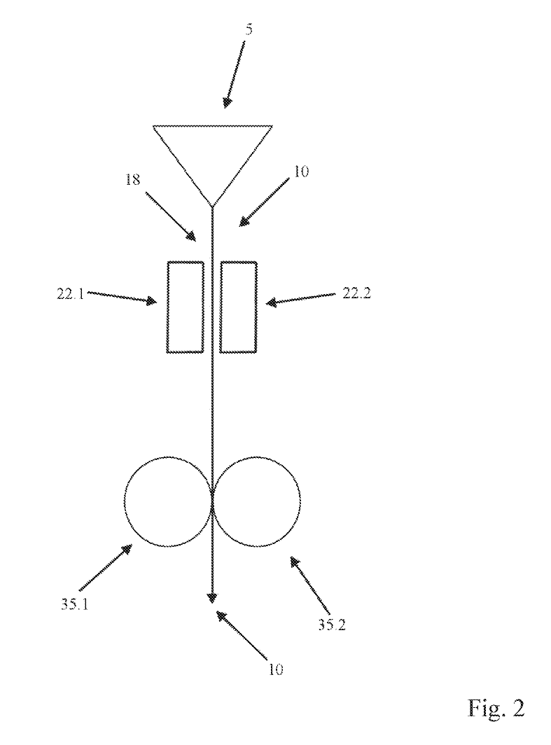

FIG. 2 shows a schematic illustration of an exemplary embodiment of another apparatus for implementing the method according to the invention. First of all, the glass ribbon 10 is prepared. The method according to the invention can also be carried out, for example, during production of the thin glass, that is, during the forming process. In the example shown, the glass ribbon 10 is drawn downward from the glass melt 5 into the drawing shaft 18. Therefore, during production, the method according to the invention is carried out in the apparatus according to the invention at the two reactive surfaces of the glass ribbon 10 directly in the drawing shaft 18. For example, it is possible, first of all, also for a deionization of the air to occur, followed by treatment with a water-containing medium and drying (not illustrated), in order to obtain the appropriate moisture in the form of a monolayer of water molecules. Preferably, the drawing shaft 18 is vertical in this case, this being illustrated by the drawing shaft components 22.1 and 22.2 other geometries are possible.

The treatment with a water-containing medium can be conducted, for example, by delivering moist air or steam. This can be supplied, for example, from above, from below, or in the middle of the drawing shaft 18 (not shown). Situated in the drawing shaft are preferably heating devices (not shown), so that heating is accomplished directly during the drawing down of the glass ribbon 10, and then the temperature is once again lowered until it reaches room temperature. For creation of the layer of water molecules, it should be noted that the temperature lies preferably below 150° C. after application of the water-containing medium so as to obtain the desired saturation of the surface of the glass ribbon. More preferably, the two glass surfaces are subjected simultaneously to the method according to the invention. For further conveyance of the glass ribbon 10, it is possible to provide appropriate devices, such as, for example, the rolls 35.1 and 35.2

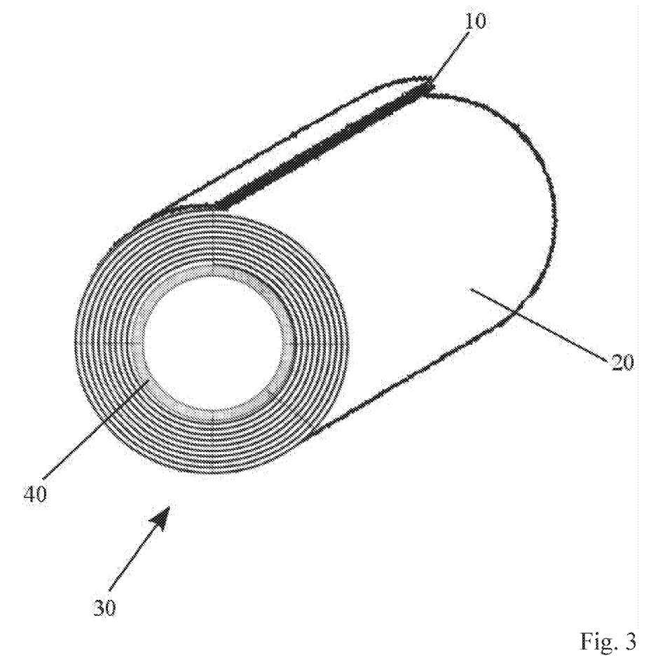

FIG. 3 is a perspective view and illustrates a wound-up glass roll 30 according to a preferred embodiment of the present invention. The glass roll 30 is formed by winding up the glass ribbon 10 around a roll core 40 in a roll, with an interleaf material 20 being situated on the surface of the glass ribbon. Obviously, it is also possible to omit, if appropriate, the roll core 40. It can be taken out of the roll 30 after winding up the glass roll 30, so as, for example, to reduce the weight of the entire glass roll 30.

The glass ribbon 10, which is wound up, is a thin glass and has a thickness in the range of ≦300 μm, for example. The glass composition can be chosen at will by the person skilled in the art. An exemplary glass is a borosilicate glass.

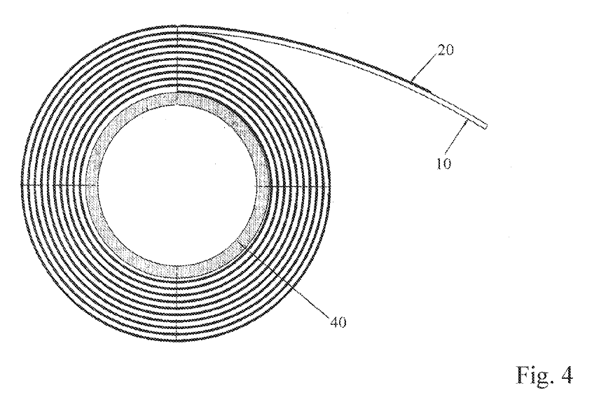

FIG. 4 shows a plan view onto the glass roll 30 of FIG. 3. The interleaf material 20 is situated on the top surface of the glass ribbon 10 and is wound up together with the glass ribbon 10 onto the reel core 40 of the glass roll 30.

FIGS. 1 to 4 illustrate possible embodiments only by way of example. They are not to be understood as being limiting, but rather merely represent examples of possible embodiments. Other possibilities of implementation are conceivable.

The present invention will be described below on the basis of an exemplary embodiment, which is not intended to limit the present invention.

### Exemplary Embodiment

A glass ribbon was produced in the usual way. The prepared thin glass ribbon had a thickness of 50 μm. The thin glass ribbon was first of all wetted by use of a water vaporizer. Subsequently, the wetted surface of the glass ribbon was dried in the air.

The electrostatic charge prior to wetting and drying of the glass ribbon was: 15 kV. After the method according to the invention was carried out, the electrostatic charge was: 0.3 kV.

After the method according the invention was carried out, the glass breakage was markedly reduced. This was ascertained by optical inspection in comparison to an identical glass roll that, however, had not been subjected to the method according to the invention.

The present invention therefore relates to a method in which a glass roll is produced, in which the electrostatic charge of the glass surface is reduced and, as a result, any undesired excess adherence of the glass surface to an interleaf material is prevented and, in consequence, glass breakage can be markedly reduced, in particular during winding up and/or unwinding of the glass roll.

What is claimed is:

1. A method for winding up a glass ribbon, comprising:
treating two surfaces of the glass ribbon with a water-containing medium;
drying the water-containing medium in order to produce a defined content of water molecules on the two surfaces by achieving, in each case, a saturation of the two surfaces with water, without an excess of water molecules being obtained; and
winding up the glass ribbon.

2. The method according to claim 1, wherein the step of treating the two surfaces with the water-containing medium does not comprise dipping the glass ribbon in the water-containing medium.

3. The method according to claim 1, wherein the step of treating the two surfaces with the water-containing medium comprises spraying the two surfaces with the water-containing medium.

4. The method according to claim 1, wherein the step of treating the two surfaces with the water-containing medium comprises vaporizing the water-containing medium onto the two surfaces.

5. The method according to claim 1, wherein the step of treating the two surfaces with the water-containing medium comprises applying the water-containing medium as a liquid.

6. The method according to claim 1, wherein the step of treating the two surfaces with the water-containing medium comprises applying the water-containing medium as a gas.

7. The method according to claim 1, wherein the step of drying the water-containing medium comprises delivering dried air to the two surfaces.

8. The method according to claim 7, further comprising preheating the dried air before delivering the dried air to the two surfaces.

9. The method according to claim 1, wherein the step of drying the water-containing medium comprises heating the two surfaces to a temperature below 150° C. and above 100° C.

10. The method according to claim 1, wherein the step of winding up the glass ribbon further comprises winding up the glass ribbon together with an interleaf material.

11. The method according to claim 10, wherein the interleaf material is a material selected from the group consisting of a polymeric material, resin material, paper material, and nonwoven material.

12. The method according to claim 10, wherein the interleaf material is a polymeric material comprising a polymer selected from the group consisting of ionomers, polyethylene, polypropylene, polyvinyl chloride, polyvinylidene chloride, polyvinyl alcohol, polypropylene, polyester, polyamide, nylon, polycarbonate, polystyrene, polyacrylonitrile, ethylene vinyl acetate copolymer, ethylene vinyl alcohol copolymer, ethylene methacrylate copolymer, polyimide, and cellophane.

13. The method according to claim 1, wherein the step of winding up the glass ribbon further comprises adjusting an air humidity to a range between 50% and 80% at 20° C.

14. The method according to claim 1, wherein the step of winding up the glass ribbon further comprises deionizing at least one of ambient air, the glass ribbon, an interleaf material, and combinations thereof.

15. The method according to claim 1, wherein the glass ribbon has a thickness of 50 μm.

16. The method according to claim 1, wherein the glass ribbon comprises a glass selected from the group consisting of lithium aluminum silicate glass, soda-lime silicate glass, borosilicate glass, aluminosilicate glass, and glass ceramic.

17. The method according to claim 1, wherein the glass ribbon comprises lithium aluminum silicate glass comprising (in wt %):

| | |
|---|---|
| Si₂ | 55-69, |
| Al₂O₃ | 19-25, |
| Li₂O | 3-5, |
| Total Na₂O + K₂O | 0-30, |
| Total MgO + CaO + SrO + BaO | 0-5, |
| ZnO | 0-4, |
| Ti₂ | 0-5, |
| Zr₂ | 0-3, |
| Total Ti₂ + Zr₂ + Sn₂ | 2-6, |
| P₂O₅ | 0-8, |
| F | 0-1, and |
| B₂O₃ | 0-2. |

18. The method according to claim 17, wherein the lithium aluminum silicate glass further comprises at least one of:
coloring oxides selected from the group consisting of Nd₂O₃, Fe₂O₃, CoO, NiO, V₂O₅, Mn₂, CuO, Ce₂, and Cr₂O₃;
rare earth oxides in contents of 0-1 wt %; and
refining agents in contents of 0-2 wt %, the refining agents being selected from the group consisting of As₂O₃, SB₂O₃, Sn₂, SO₃, Cl, F, and Ce₂.

19. The method according to claim 1, wherein the glass ribbon comprises soda-lime silicate glass comprising (in wt %):

| | |
|---|---|
| Si₂ | 40-80, |
| Al₂O₃ | 0-6, |
| B₂O₃ | 0-5, |
| Total Li₂O + Na₂O + K₂O | 5-30, |
| Total MgO + CaO + SrO + BaO + ZnO | 5-30, |
| Total Ti₂ + Zr₂ | 0-7, and |
| P₂O₅ | 0-2. |

20. The method according to claim 19, wherein the soda-lime silicate glass further comprises at least one of:
coloring oxides selected from the group consisting of Nd₂O₃, Fe₂O₃, CoO, NiO, V₂O₅, Mn₂, CuO, Ce₂, and Cr₂O₃;
rare earth oxides in contents of 0-15 wt %; and
refining agents in contents of 0-2 wt %, the refining agents being selected from the group consisting of As₂O₃, SB₂O₃, Sn₂, SO₃, Cl, F, and Ce₂.

21. The method according to claim 1, wherein the glass ribbon comprises borosilicate glass comprising (in wt %):

| | |
|---|---|
| Si₂ | 60-85, |
| Al₂O₃ | 1-10, |
| B₂O₃ | 5-20, |
| Total Li₂O + Na₂O + K₂O | 2-16, |
| Total MgO + CaO + SrO + BaO + ZnO | 0-15, |
| Total Ti₂ + Zr₂ | 0-5, and |
| P₂O₅ | 0-2. |

22. The method according to claim 21, wherein the borosilicate glass further comprises at least one of:
coloring oxides selected from the group consisting of Nd₂O₃, Fe₂O₃, CoO, NiO, V₂O₅, Mn₂, CuO, Ce₂, and Cr₂O₃;
rare earth oxides in contents of 0-15 wt %; and
refining agents in contents of 0-2 wt %, the refining agents being selected from the group consisting of As₂O₃, SB₂O₃, Sn₂, SO₃, Cl, F, and Ce₂.

23. The method according to claim 1, wherein the glass ribbon comprises alkali aluminosilicate glass comprising (in wt %):

| | |
|---|---|
| Si₂ | 40-75, |
| Al₂O₃ | 10-30, |
| B₂O₃ | 0-20, |
| Total Li₂O + Na₂O + K₂O | 4-30, |
| Total MgO + CaO + SrO + BaO + ZnO | 0-15, |
| Total Ti₂ + Zr₂ | 0-15, and |
| P₂O₅ | 0-10. |

24. The method according to claim 23, wherein the alkali aluminosilicate glass further comprises at least one of:
coloring oxides selected from the group consisting of Nd₂O₃, Fe₂O₃, CoO, NiO, V₂O₅, Mn₂, CuO, Ce₂, and Cr₂O₃;
rare earth oxides in contents of 0-15 wt %; and
refining agents in contents of 0-2 wt %, the refining agents being selected from the group consisting of As₂O₃, SB₂O₃, Sn₂, SO₃, Cl, F, and Ce₂.

25. The method according to claim 1, wherein the glass ribbon comprises alkali-free aluminosilicate glass comprising (in wt %):

| | |
|---|---|
| Si₂ | 50-75, |
| Al₂O₃ | 7-25, |
| B₂O₃ | 0-20, |
| Total Li₂O + Na₂O + K₂O | 0-0.1, |
| Total MgO + CaO + SrO + BaO + ZnO | 5-25, |
| Total Ti₂ + Zr₂ | 0-10, and |
| P₂O₅ | 0-5. |

26. The method according to claim 25, wherein the alkali-free aluminosilicate glass further comprises at least one of:
coloring oxides selected from the group consisting of Nd₂O₃, Fe₂O₃, CoO, NiO, V₂O₅, Mn₂, CuO, Ce₂, and Cr₂O₃;
rare earth oxides in contents of 0-15 wt %; and
refining agents in contents of 0-2 wt %, the refining agents being selected from the group consisting of As₂O₃, SB₂O₃, Sn₂, SO₃, Cl, F, and Ce₂.

27. The method according to claim 1, wherein the glass ribbon comprises low-alkali aluminosilicate glass comprising (in wt %):

| | |
|---|---|
| Si₂ | 50-75, |
| Al₂O₃ | 7-25, |
| B₂O₃ | 0-20, |
| Total Li₂O + Na₂O + K₂O | 0-4, |
| Total MgO + CaO + SrO + BaO + ZnO | 5-25, |
| Total Ti₂ + Zr₂ | 0-10, and |
| P₂O₅ | 0-5. |

28. The method according to claim 27, wherein the low-alkali aluminosilicate glass further comprises at least one of:
coloring oxides selected from the group consisting of Nd₂O₃, Fe₂O₃, CoO, NiO, V₂O₅, Mn₂, CuO, Ce₂, and Cr₂O₃;
rare earth oxides in contents of 0-15 wt %; and
refining agents in contents of 0-2 wt %, the refining agents being selected from the group consisting of such as As₂O₃, SB₂O₃, Sn₂, SO₃, Cl, F, and Ce₂.

29. The method according to claim 1, further comprising attaining an electrostatic charge of the glass ribbon in the range of 0 to 1 kV during the treating and drying steps.

30. An apparatus for winding up a glass ribbon, comprising:
a treating device configured to treat two surfaces of the glass ribbon with a water-containing medium by spraying or vaporizing the two surfaces with the water-containing medium; and
a drying device configured to dry the two surfaces of the glass ribbon with retention of a defined content of water molecules on the two surfaces by achieving, for each of them, a saturation of the two surfaces with water, without obtaining an excess of water molecules.

31. A glass comprising two surfaces each have a defined content of water molecules on the surfaces, wherein, in each case, a saturation of the surfaces with water exists, without any excess of water molecules being present.

32. The glass according to claim 31, wherein the glass is selected from the group consisting of a glass ribbon, a thin glass ribbon, and a glass sheet.

33. A glass roll comprising a glass ribbon according to claim 31 wound up together with a polymeric interleaf material, wherein the glass ribbon has an electrostatic charge in a range of 0 to 1 kV.
